(19) United States
(12) Patent Application Publication
(10) Pub. No.: US 2015/0006225 A1
(43) Pub. Date: Jan. 1, 2015

(54) PROJECT MANAGEMENT APPLICATION WITH BUSINESS RULES FRAMEWORK

(71) Applicants: SHREEVATHSA S, Bangalore (IN); Vikram Khatri, Bangalore (IN)

(72) Inventors: SHREEVATHSA S, Bangalore (IN); Vikram Khatri, Bangalore (IN)

(21) Appl. No.: 13/929,780

(22) Filed: Jun. 28, 2013

(51) Int. Cl. G06Q 10/06

(52) U.S. Cl. CPC G06Q 10/06313
USPC 705/7.23

(57) ABSTRACT

To generate a report, a project management application retrieves data including attributes, associated attribute values, enterprise project planning elements, and associated planning values from a data store. On the retrieved data, the attribute is selected via a user interface. The attribute value of the selected attribute is determined and a business rule model is instantiated to select a business rule. The selected business rule is executed on the data to establish a relation between the enterprise project planning elements and the selected attributes. A report including the enterprise project planning element, the associated planning value, and an aggregate of attribute value is generated and displayed on a user interface.

### BACKGROUND

Enterprises use project management applications for managing projects. The management of projects may be broadly divided into planning phase and execution phase. The planning phase constitutes devising a blueprint for execution of the project. The planning phase of the project generates high-level data including estimates indicating numerical values associated with the different phases for project development. The high-level data including the estimates planning elements may further be fragmented to represent actual data. The actual data may include values indicating an actual cost incurred for executing the planning element. An end user may be interested in investigating the estimates associated with the planning elements against the actual cost incurred for each planning element associated with the project.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a system for generating a report, according to an embodiment.

FIG. 2 is a flow diagram illustrating a process for generating a report, according to an embodiment.

FIG. 3 is a block diagram illustrating a system for general report, according to an embodiment.

FIG. 4A is a table illustrating a dataset including enterprise project planning elements residing in a data store, according to an embodiment.

FIG. 4B is a table illustrating a dataset including actual data residing in a data store, according to an embodiment.

FIG. 4C is a table illustrating business rules residing in a data store, according to an embodiment.

FIG. 4D is a user interface illustrating a generated report, according to an embodiment.

FIG. 5 is a block diagram of a computer system, according to an embodiment.

### DETAILED DESCRIPTION

Embodiments of techniques for project management application with business rules framework are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one Of more embodiments. Thus, the appearances of these phrases in various places throughout this specification are not necessarily all referring to the same embodiment. Furthermore, the particular features, structures, or characteristics may be combined in any suitable manner in one or more embodiments.

Demand for project management applications has witnessed an exponential growth A project management application may assist a user to plan, organize and manage projects. The project management application may be a standalone application installed on a general purpose computer or a web based application. The planning operations that may be carried out by the project management application include developing an estimate of resources, for example, human capital, material, equipment, and the like; an estimate of budget and time for the project development, and the like. Such planning operations lead to generation of planning data representing high level data. The high level data may include planning elements, herein referred to as “enterprise project planning elements,” and associated “planning values.” The planning values may indicate, for example, an estimate in terms of cost; time for execution of project; resources in terms of human capital, equipment etc., that may be used to place a bid for procuring projects.

Upon procuring the projects, the planning values may be used as a platform for devising a detailed plan for execution of the project. Such detailed planning may include details related to resources in terms of units consumed, for example resource costs related to equipment, wages paid to employees working on the project, travel costs, and the like. Such detailed planning operations lead to generation of data, herein referred to as “actual data,” including attributes and associated attribute values. The user using the project management application may be interested in matching the planning values and the actual values. The end user may generate a report including the actual data and the enterprise planning elements. The generated report may include actual values indicating the actual cost incurred and the planning values indicating the estimated cost for executing the project.

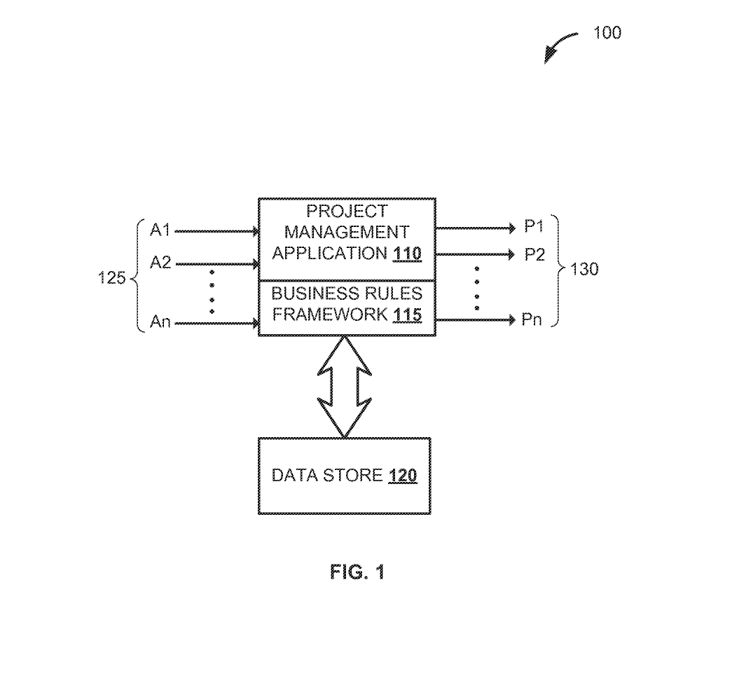

FIG. 1 is a block diagram illustrating system 100 for generating a report, according to an embodiment. In an embodiment, system 100 includes project management application 110. Project management application 110 is communicatively coupled to data store 120. Data store 120 may include a database, an in-memory database, an operational data store, a web based data service, and the like, containing structured and unstructured data. Data store 120 includes data related to projects that may be currently under a planning phase, an execution phase, a combination thereof or may be pipelined for execution in a near future. The data related to the projects includes enterprise project planning elements 130 and associated planning values residing in a table in data store 120. Enterprise project planning elements 130 are elements that may be defined based on known metrics. For example, enterprise project planning elements 130 may be defined by decomposing the project into activities such as developing a Blueprint; developing one or inure applications for the project; application testing and bug fixing; application deployment, and the like. Each enterprise project element 130 is associated with a value indicating the estimate in terms of budget, cost, resources and the like. Enterprise project planning elements 130 and the associated planning values represent planning data.

The planning data may be used as a platform to devise a detailed plan for execution of the project. The detailed plan for executing the project includes the actual costs and associated resources, represented by attributes 125 and associated attribute values. Attributes 125 and the associated attribute values indicate actual data in terms of cost, budget, time, and the like, for the execution of the project. The actual data including attributes 125 and the associated attribute values may be stored in a table residing in data store 120. Enterprise project planning elements 130 may translate into detailed roadmap of concrete deliverables. For example, the actual data may include tasks, responsibilities, time frame for execution of each enterprise project planning element 130, and the like. The actual data may further include an attribute indicating the phase of execution of project, for example Phase 1, Phase 2, and the like; an attribute indicating an activity type, for example, architect analysis, requirement gathering, functional module design, and the like.

In an embodiment, project management application 110 is integrated to work in conjunction with business rules framework (BRF) 115. BRF 115 includes a business rules engine configured to communicatively couple with a structure, for example a table residing in data store 120 and including business rules. The business rules may be configured during a design time and may be specific to the project or may be modified based on the project and business needs. A user may select one or more attributes 125 to be included for generating a report. The report includes enterprise project planning elements 130, planning values and attribute values of the selected attributes. The user selection is received as an input by BRF 115. Based on the selected attributes, the business rules engine is instantiated to determine one or more business rules that are executed on the actual data. The business rules engine determines the attribute values associated with the selected attributes. Based on the determined attribute values, the business rules engine selects at least one business rule to be executed. The determined at least one business rule is executed on the actual data including the attributes and the associated attribute values for establishing a relation between enterprise project planning elements 130, and the attribute values. The established relation enriches the attribute values, and hence represents enriched actual data.

In an embodiment, project management application 110 generates a report including the enriched actual data and enterprise project planning elements 130. The values associated with the enriched data indicate the actual cost incurred, while the planning values associated with enterprise project planning elements 130 indicate the estimated values, for execution of the project. The report therefore provides an insight on the estimated cost against the actual cost incurred for execution of the project.

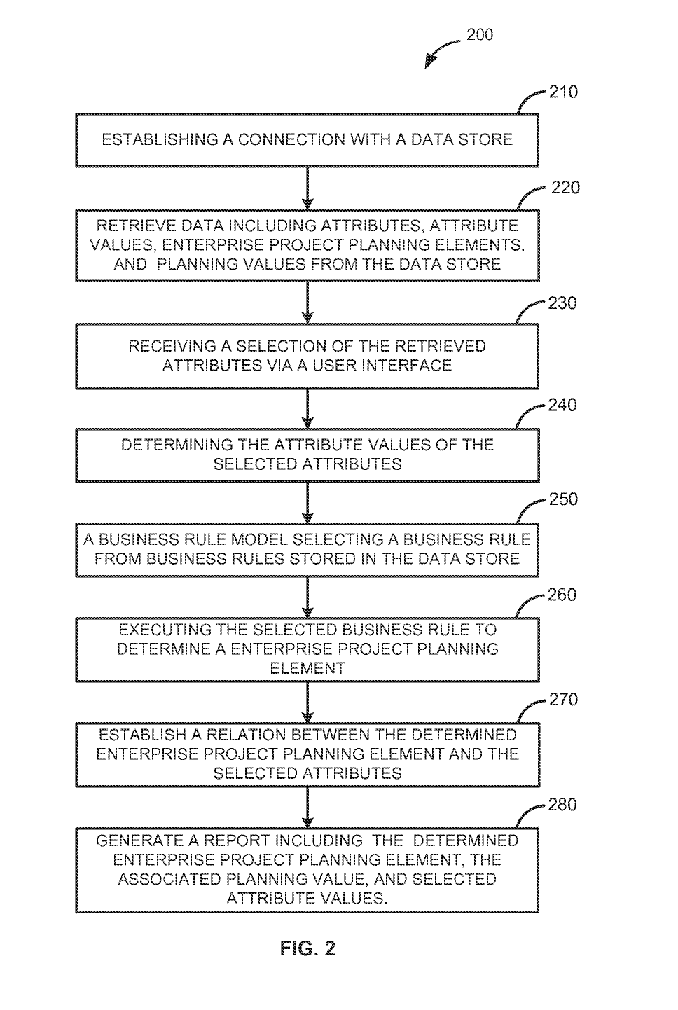

FIG. 2 is a flow diagram illustrating process 200 for generating a report, according to an embodiment. Process 200 includes, at 210, establishing a connection with a data store by a project management application including an integrated BRF. Upon establishing the connection, data including attributes, associated attribute values, enterprise project planning elements and associated planning values are retrieved from the data store, at 220. At run time, one or inure attributes are selected via a user interface, at 230. The values of the selected attributes are determined, at the process step 240. Based on the determined attributes values, a business rule model selects a business rule from the business rules stored in the data store, at 250. The selected business rule is executed to determine at least one enterprise project planning element, at 260, A relation is established between the determined at least one enterprise project planning element and the selected attributes, at 270. A report including the enterprise project planning element, the associated planning value and the selected attributed values is generated, at 280.

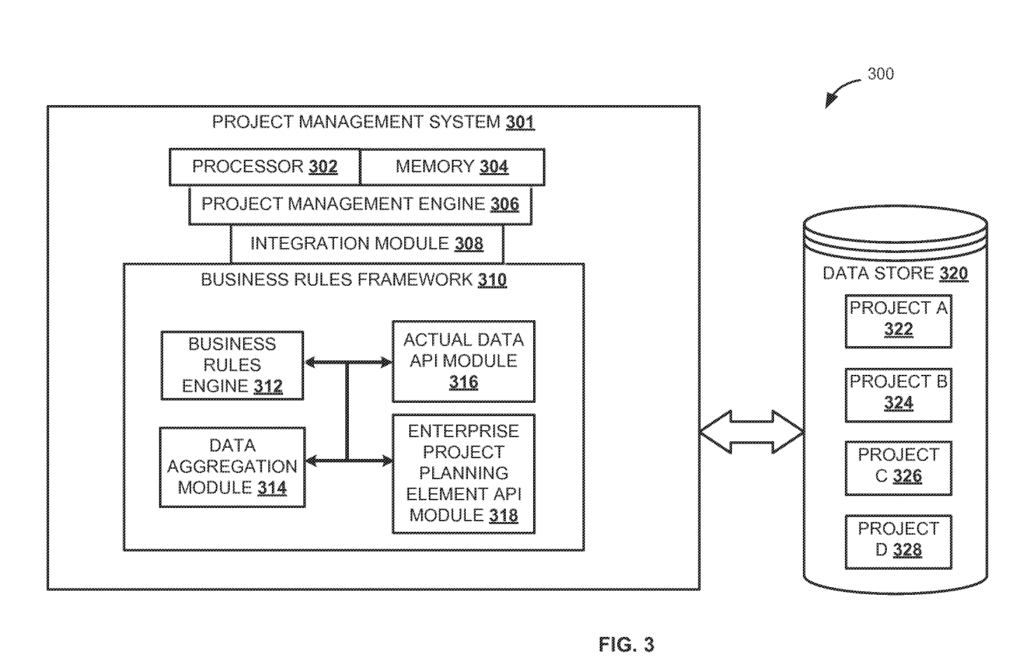

FIG. 3 is a block diagram illustrating system 300 for generating a report, according to an embodiment. In an embodiment, project management system 301 for generating a report includes processor 302, memory 304, project management engine 306, integration module 308, and business rules framework 310. The project management engine 306 is integrated with business rules framework (BRF) 310 via integration module 308. Project management engine 306 works in conjunction with BTU 310 to generate the report, BRF 310 includes business rules engine 312, data aggregation module 314, actual data application program interface (APT) module 316, and enterprise project planning element API module 318. Project management system 301 is communicatively coupled to data store 320 and may be configured to provide operations, for example, retrieving, reading, writing, saving, updating, and the like, on the data stored in data store 320.

In an embodiment, data store 320 includes data related to projects A 322, B 324, C 326 and D 328 that may be in a planning phase, an execution phase, a combination thereof or pipelined for execution in a near future. The data associated with the projects A 322-D 328 include enterprise project planning elements and associated planning values representing high level data. The high level data including planning data, indicates an estimate of, for example cost of resources including human capital, material, equipment, and the like; cost for executing each phase, for example, design, analysis, development, testing, deployment, and the like, of the project; cost of developing, for example, prototypes or proof of concept (POC) for critical phases of the project, and the like.

In an embodiment, such high level data may be used as a platform to devise a detailed plan for execution of the project. For instance, when the project under the planning phase enters into the execution phase, the planning data generated during the planning phase of the project may establish a platform to carry out detailed plan of execution. The detailed plan for executing the project may include work breakdown elements, for example, specific phase of execution and attributes, such as, type of activities, associated with project development, and the like. The work breakdown elements represent “actual data.” The actual data may include associated values, for example, attribute values. For instance, the actual data represents the type of activity, like project requirement analysis, project design, project development, project testing, project deployment, etc.; resources, for example human capital, equipment, customized software packages and applications for handling the above activity types, and the like.

In an embodiment, BRF 310 includes business rules engine 312 that may be configured with business rules to perform defined business processes. Business rules may be a sequence of procedural statements configured to regulate the business process or business data. The business rules in the business rules engine may be configured at design time. The business rules may be configured to enforce specific constraints on the business processes or the business data based on business needs. The business rules configured by a user may be for a specific project and may be customized or modified during design time, based on the project needs. Hence BRF 310 offers a flexible framework to modify the business rules during design time, based on the project and business need.

In an embodiment, the business rules configured during design time are executed by system 301 during run time. During run time, the user may select the attributes of the actual data via a user interface, for example a first user interface associated with actual data API module 316. Based on the selected attributes, the business rules engine is instantiated. The business rules engine determines the values of the selected attributes. Based on the determined attribute values, the business rules engine determines and selects at least one business rule from the business rules stored in the data store. The selected business rule is executed during run time on the actual data, including the attributes and the associated attribute values. The execution of the selected business rule establishes a relation between the enterprise project planning elements, the attributes and the associated attribute values. For example, based on the selected attributes and the determined values of the selected attributes, business rules engine 312 determines the business rule to be executed. For example, if the determined business rule is defined as:

If (Attribute=‘Architect Analysis’ AND Attribute 2=‘Onsite’), then PLAN ELEMENT=Blueprint.

The business rules engine 312 determines the attribute values of ‘Attribute 1’ and ‘Attribute 2’ to be equal to ‘Architect Analysis’ and ‘Onsite,’ respectively. Based on the determined attribute values, business rules engine 312 enforces constraints via the statements defined in the business rule to establish a relation between the attributes, the associated attribute values and the enterprise project planning elements. In the example above, the ‘PLAN_ELEMENT’ is assigned a value ‘Blueprint’ based on execution of the defined business rule above.

In an embodiment, actual data API module 316 is communicatively coupled to data store 320 and business rules engine 312. The actual data API module 316 is associated with a user interface (not shown), for example a first user interface, a second user interface, and the like, that provides a set of functionalities. The actual data API module 316 is configured to operate, for example, retrieve, save, update, delete and the like, on the actual data including the attributes and the associated attribute values stored in data More 320. The retrieved attribute values are rendered on the associated user interface. The user interface is configured to receive an input from the user. The business rules engine 312 receives the selected attributes, and determines the attribute values and the business rule to be executed.

In an embodiment, enterprise project planning element API module 318 is communicatively coupled to the data store 320 and business rules engine 312. The enterprise project planning element API module 318 is associated with a user interface (not shown), for example a first user interoffice, a second user interface, and the like, that provides a set of functionalities. The enterprise project planning element API module 318 is configured to operate, for example, retrieve, save, update, delete and the like, on the enterprise project planning elements, and associated planning values. The planning values may be rendered on the user interface associated with the enterprise project planning element API module 318. The business rules engine 312 determines and associates an enterprise project planning element with a planning value based on the selected attribute and the determined attribute value, as explained above. In an embodiment, project management engine 306 generates a report. For example, the generated report includes actual values indicating the actual cost incurred, and the planning values indicating the estimated cost for executing the project. The data aggregation module 314 is communicatively coupled to business rules engine 312, actual data API module 316, and enterprise project planning element API module 318. The data aggregation module 314 is configured to aggregate the attribute values corresponding to the determined enterprise project planning element.

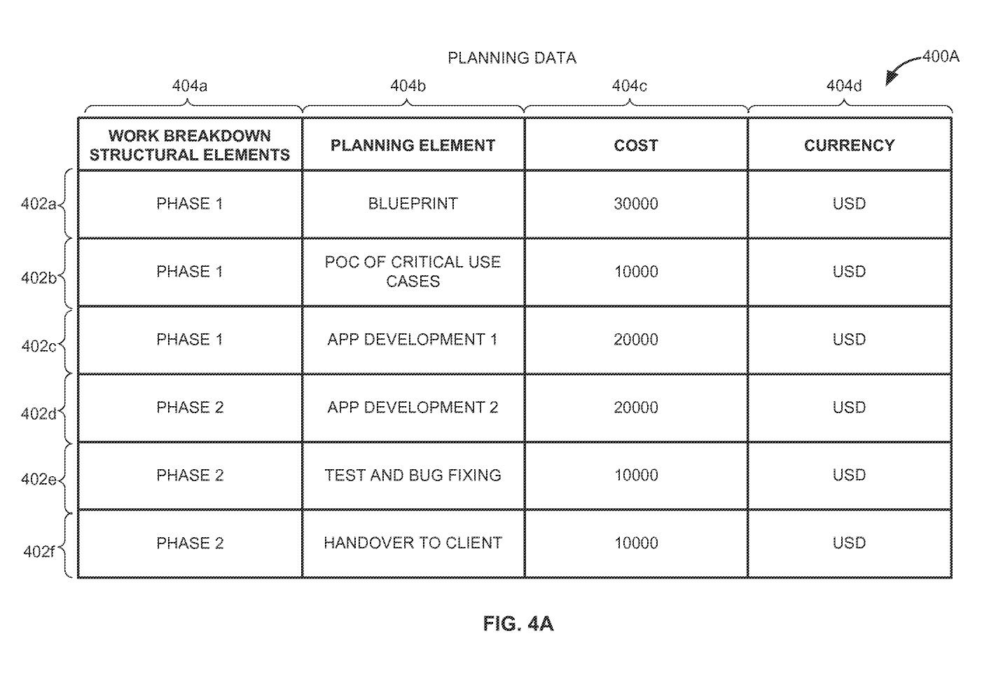

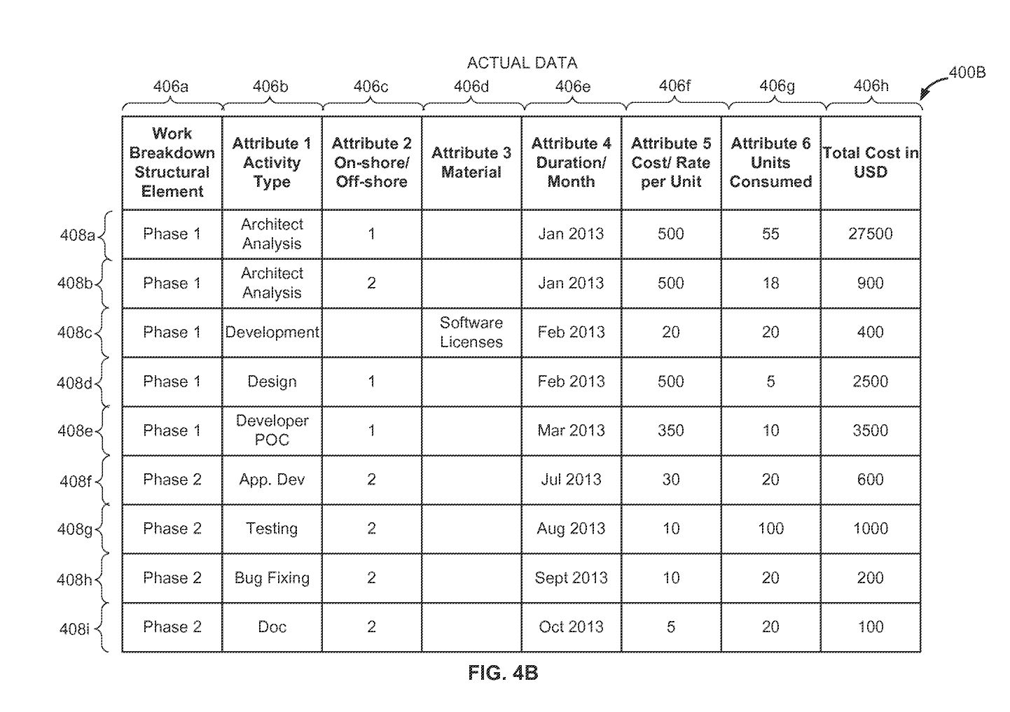

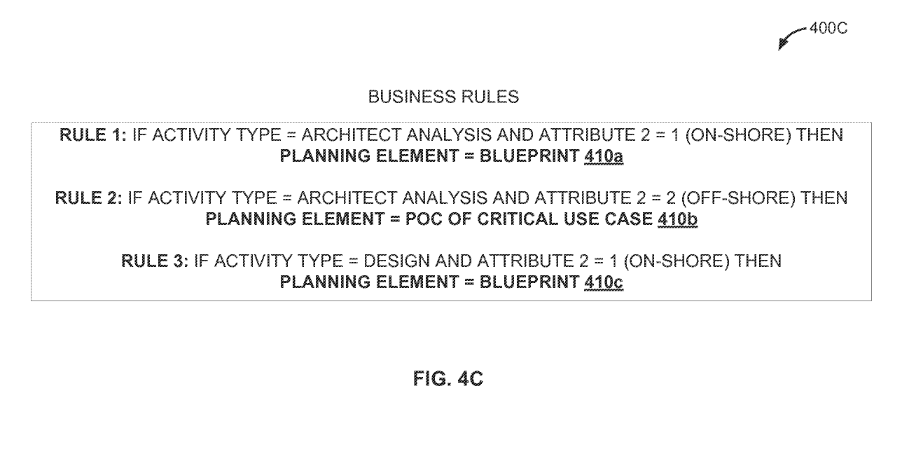

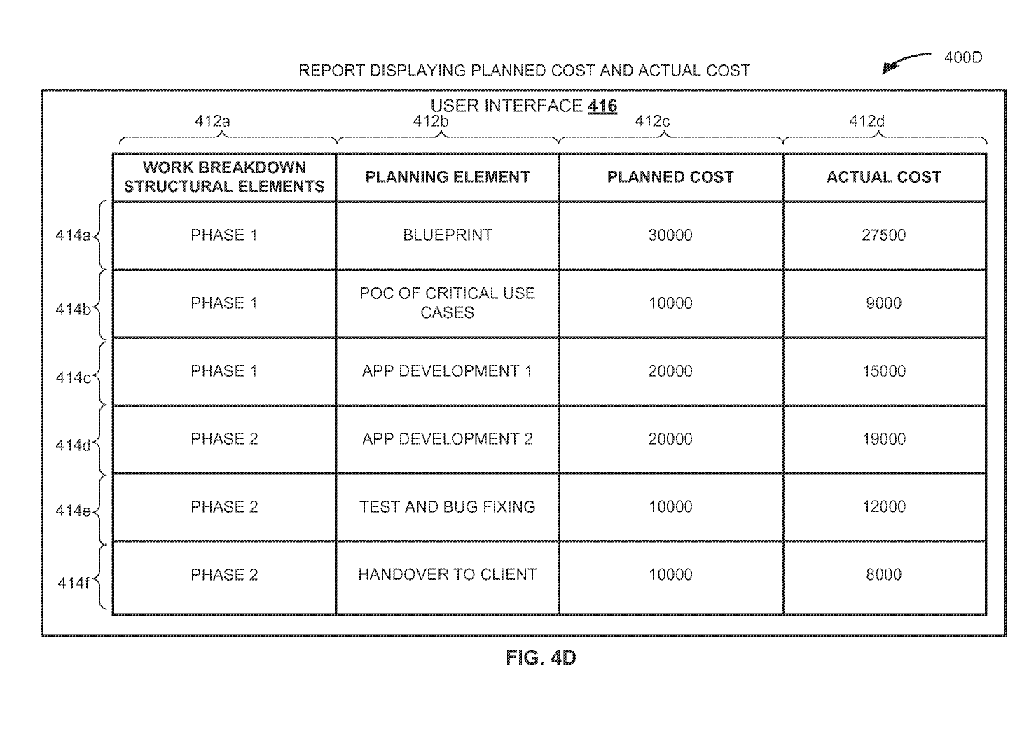

FIG. 4A is table 400A illustrating a dataset including enterprise project planning elements residing in a data store, according to an embodiment. Planning data associated with a project may be stored in table 400A, residing in data store 320 and includes work breakdown structural elements, enterprise project planning elements and associated planning values. As illustrated in FIG. 4A, planning data in table 400A includes enterprise project planning elements, the associated values and the work break down structural elements represented in multiple cells arranged in rows and columns. The columns 404a, 404b, 404c and 404d of the table 400A include “Work breakdown structural elements” 404a, “Enterprise project planning element” 404b, herein referred to as “Planning Element” and associated “Cost” 404c and “Currency” 404d. The work breakdown structural element provides information related to the execution phase, for example Phase 1, Phase 2, etc. of the project. The values corresponding to each of the columns above are represented by rows 402a, 402b, 402c, 402d, 402e and 402f. For instance, the values corresponding to the first row 402a include “Phase 1,” “Blueprint,” “30,000,” and “USD.”

FIG. 4B is table 400B illustrating of dataset including actual data residing in a data store, according to an embodiment. Actual data associated with a project may be stored in table 400B residing in data store 320 and includes, for example, work breakdown structural element 406a, attributes 406b including activity type; attribute 406c indicating location of execution of project, like, On-shore Of Off-shore; attribute 406d indicating the equipment/material associated with the project; attribute 406e indicating the duration or specific month associated with activity type; cost or budget per unit 406f associated with execution of the project; attribute 406g indicating the total units consumed for execution of the project; and total cost 406h associated for the execution. As illustrated in FIG. 4B, the actual data in table 400B includes the above attributes and associated alphanumerical values arranged in multiple cells arranged in rows and columns. The columns 406a, 406b, 406c, 406d, 406e, 406f, 406g and 406h of the table 400B include the above described attributes. The work breakdown structural element 406a provides information related to the execution phase, for example Phase 1, Phase 2, etc. of the project. The alphanumeric values corresponding to each of the columns above are represented by rows 408a, 408h, 408c, 408d, 408e, 408f, 408g, 408h and 408i. For instance, the values corresponding to the first row 408a include “Phase 1,” “Architect Analysis,” “1,” “−,” “January 2013,” “500,” “55,” and “27500.”

FIG. 4C is table illustrating business rules residing in a data store, according to an embodiment. In an embodiment, table 400C residing in data store 320 includes business rules, for example, ‘RULE 1’ 410a, ‘RULE 2’ 410b, and ‘RULE 3’ 410c that are configured during design time. The business rules ‘RULE 1,’ RULE ‘2,’ and ‘RULE 3’ may be customized or modified based on project requirements or business needs. The determination selection and execution of the business rules 410a, 410b, and 410c is explained, for example, in the description of FIG. 3. As illustrated in FIG. 4C, the table 400C includes business rules configured during design time as, for example:
Rule 1: If (Activity Type=Architect Analysis AND Attribute 2=1 (On-shore)), then Planning Element=BluePrint 410a;
Rule 2: If (Activity Type=Architect Analysis AND Attribute 2=2 (Off-shore)), then Planning Element=POC of critical use case 410b;
Rule 3: If (Activity Type=‘Design’ AND Attribute 2=1 (On-Shore)), then Planning Element=BluePrint 410c;

During system 301 run time, business rules engine 312: determines the attribute values of Activity Type and Attribute 2 to be respectively be equal to “Architect Analysis” and On-shore; determines and selects business rule, namely, RULE 1 410a, Based on the selected business rule (in this case RULE 1 410a), business rules engine 312 executes the statements defined in the business rule to establish the relation between the attributes, the associated attribute values and the enterprise project planning elements.

FIG. 4D is user interface 416 illustrating a generated report, according to an embodiment. In an embodiment, report 400D including the work breakdown structural elements 412a, the planning elements 412b, planned cost 412c and actual cost 412d is generated by system 300 and displayed on a user interface 416. As exemplarily illustrated in FIG. 4D, data in columns include “Work Breakdown Structural Elements” 412a, “Enterprise project planning element” 412b, “Planned Cost” 412c and “Actual Cost” 412d. The values of the above columns 412a-412d are represented by the rows 414a-414f. The generation of report 400D is as explained in the detailed description of FIG. 3.

In an embodiment, data store 320 includes: enterprise project planning elements, and associated planning values representing the planning data; actual data including details of tasks, responsibilities, time frame for execution of the project and the like. A user may be interested in investigating the estimates associated with the planning element, for example ‘Application Development 1,’ against the actual cost incurred the planning element ‘Application Development 1’, The user access system 301 to access this information. For example, the cost estimated for the enterprise project planning element ‘Application Development 1’ is 520,000 USD. System 301 retrieves actual data including attributes and associated values and displays them on a user interface.

The user interface is configured to receive user input. The user may select one or more attributes. For example, the user selects an attribute: Activity Type=‘Developer−App development’; and Attribute 2=1 (On-Shore). As explained in description, for example of FIG. 3, the business rules engine 312 of system 301 determines the above selected attribute values. Based on these determined values, business rules engine 312 of system 301 determines and selects at least one business rule to be executed. For example, the business rule selected for execution is:
Rule 4: If (Activity Type=‘Developer−App development’ AND Attribute 2=1 (On-Shore), then Plan Element=‘Application Development 1’).

The business rules engine 312 executes the above business rule and enforces the constraints defined in the business rule. The execution of business rule establishes a relation between the enterprise project planning element ‘Application Development 1’ and the selected attributes ‘Activity Type’ and ‘Attribute 2.’ The actual cost associated for execution of the planning element ‘Application Development 1’ is computed. For example, the actual cost may be computed to be equal to $15,000 USD. A report including the enterprise project planning element ‘Application Development 1’, the estimated cost of $20,000 USD and the actual cost incurred of $15,000 USD is displayed to the user on the user interface.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

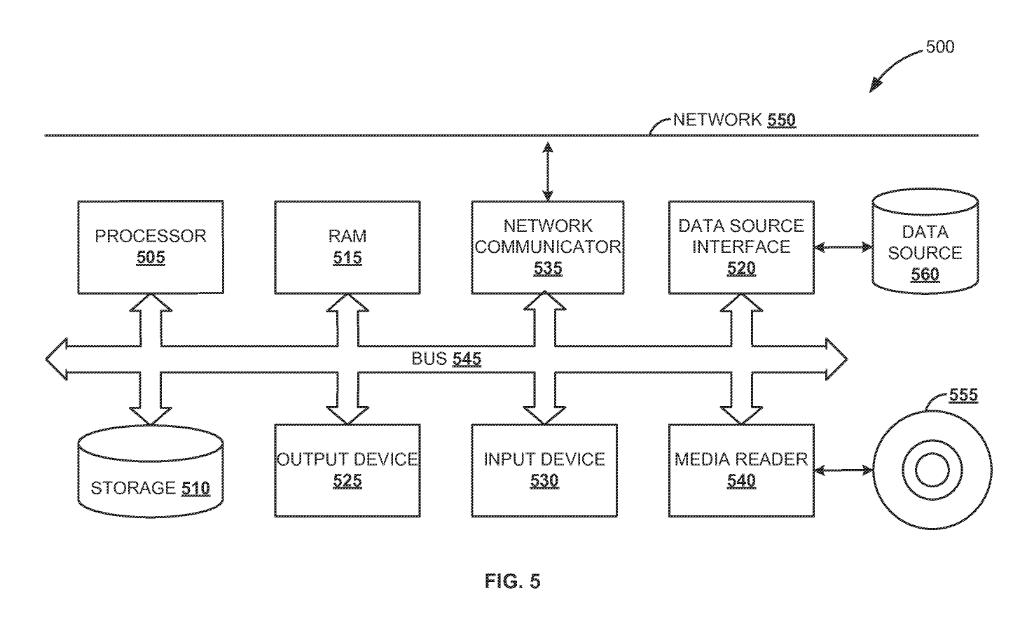

FIG. 5 is a block diagram of an exemplary computer system 500, according to an embodiment. The computer system 500 includes a processor 505 that executes software instructions or code stored on a computer readable storage medium 555 to perform the above-illustrated methods. The processor 505 can include a plurality of cores. The computer system 500 includes a media reader 540 to read the instructions from the computer readable storage medium 555 and store the instructions in storage 510 Of in random access memory (RAM) 515. The storage 510 provides a large space for keeping static data where at least some instructions could be stored for later execution. According to sonic embodiments, such as some in-memory computing system embodiments, the RAM 515 can have sufficient storage capacity to store much of the data required for processing in the RAM 515 instead of in the storage 510. In some embodiments, all of the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. in some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited ext files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to generate a report, comprising:
establishing a connection with a data store to retrieve a plurality of attributes, one or more associated attribute values for each of the plurality of attributes, a plurality of enterprise project planning elements, and one or more associated planning values for each of the plurality of enterprise project planning elements, from the data store;
receiving a selection of at least one attribute from the plurality of retrieved attributes via a first user interface;
determining at least one attribute value associated with the at least one selected attribute;
based on the determined at least one attribute value, a business rule model selecting at least one business rule from a plurality of business rules stored in the data store;
a processor of a computer executing the selected at least one business rule to determine at least one enterprise project planning element of the plurality of enterprise project planning elements for establishing a relation between the at least one determined enterprise project planning element and the at least one selected attribute; and
generating a report including the at least one determined enterprise project planning element, at least one associated planning value, and the at least one selected attribute value.

2. The computer implemented method of claim 1, wherein the established relation enriches the selected at least one attribute with the at least one determined enterprise project element.

3. The computer implemented method of claim 1, wherein the generated report includes an aggregate of the at least one attribute value associated with the determined at least one enterprise project element.

4. The computer implemented method of claim 1, wherein the plurality of business rules stored in the data store is configured during design time.

5. The computer implemented method of claim 1, wherein the at least one selected business rule is executed during run time.

6. The computer implemented method of claim 1, wherein the generated report is displayed on a second user interface.

7. An article of manufacture including a non-transitory computer readable storage medium to tangibly store instructions, which when executed by a computer, cause the computer to:
establish a connection with a data store to retrieve a plurality of attributes, one or more associated attribute values for each of the plurality of attributes, a plurality of enterprise project planning elements, and one or more associated planning values for each of the plurality of enterprise project planning elements, from the data store;
receive a selection of at least one attribute from the plurality of retrieved attributes via a first user interface;
determine at least one attribute value associated with the at least one selected attribute;
based on the determined at least one attribute value, a business rule model selecting at least one business rule from a plurality of business rules stored in the data store;
execute the selected at least one business rule to determine at least one enterprise project planning element of the plurality of enterprise project planning elements for establishing a relation between the at least one determined enterprise project planning element and the at least one selected attribute; and
generate a report including the at least one determined enterprise project planning element, at least one associated planning value and the at least one selected attribute value.

8. The article of manufacture of claim 7, wherein the established relation enriches the selected at least one attribute with the at least one determined enterprise project element.

9. The article of manufacture of claim 7, wherein the generated report includes an aggregate of the at least one attribute value associated with the determined at least one enterprise project element.

10. The article of manufacture of claim 7, wherein the plurality of business rules stored in the data store is configured during design time.

11. The article of manufacture of claim 7, wherein the at least one selected business rule is executed during run time.

12. The article of manufacture of claim 7, wherein the generated report is displayed on a second user interface.

13. A computer implemented system to generate a report, comprising:
a processor operable to read and execute instructions stored in one or more memory elements;
a data store to store a plurality of attributes, one or more associated attribute values for each of the plurality of attributes, a plurality of enterprise project planning elements, one or more associated planning values for each of the plurality of enterprise project planning elements, and a plurality of business rules associated with one or more projects;
a project management engine to retrieve the plurality of attributes, the plurality of one or more associated attribute values, the plurality of enterprise project planning elements, and the plurality of one or more associated planning values from the data store;
a user output device to display at least one retrieved attribute, at least one associated attribute value, at least one enterprise project planning element, and at least one associated planning value on a first user interface;
a user input device to select the at least one retrieved attribute from the plurality of attributes;
a business rules engine, configured to:
determine at least one attribute value of at least one selected attribute;
select at least one business rule from a plurality of business rules stored in the data store: and
execute at least one selected business rule to determine at least one enterprise project planning element for establishing a relation with the at least one determined enterprise project planning element, and the at least one selected attribute; and
the project management engine configured to generate a report including the at least one determined enterprise project planning element, at least one associated planning value, and the at least one selected attribute value.

14. The computer implemented system of claim 13, further comprising: a data aggregation module configured to aggregate at least one attribute value associated with the determined enterprise project planning element.

15. The computer implemented system of claim 13, further comprising: an actual data application program interface module configured to retrieve at least one attribute of the plurality of attributes and at least one associated attribute value of the plurality of associated attribute values.

16. The computer implemented system of claim 13, further comprising: an enterprise project planning element module configured to retrieve at least one enterprise project planning element of the plurality of enterprise project planning elements and at least one associated planning value of the plurality of associated attribute values.

17. The computer implemented system of claim 13, wherein the established relation enriches the selected at least one attribute with the at least one determined enterprise project element.

18. The computer implemented system of claim 13, wherein the generated report includes an aggregate of at least one attribute value associated with the determined at least one enterprise project element.

19. The computer implemented system of claim 13, wherein at least one selected business rule of the plurality of business rules is executed during the run time.

20. The computer implemented system of claim 13, wherein the generated report is displayed on a second user interface associated with the user output device.
